(19) United States
(12) Patent Application Publication
(10) Pub. No.: US 2012/0023031 A1
(43) Pub. Date: Jan. 26, 2012

(54) BUSINESS MATCHING SYSTEM AND METHODS THEREOF FOR THE CREATIVE ARTS INDUSTRIES

(76) Inventor: ANNE GALYA, Monroe, NJ (US)

(21) Appl. No.: 13/189,528

(22) Filed: Jul. 24, 2011

Related U.S. Application Data
(60) Provisional application No. 61/367,253, filed on Jul. 23, 2010.
(60) Provisional application No. 61/367,213, filed on Jul. 23, 2010.

(51) Int. Cl. G06Q 10/00

(52) U.S. Cl. 705/321

(57) ABSTRACT

Embodiments of the present invention are generally related to a business matching system and methods thereof. More specifically, embodiments of the present invention relate to a network-based system for matching a candidate with an open position of an employer within a predetermined creative arts industry and methods of utilizing and implementing the same. In one embodiment, a method of matching business personnel comprises: receiving, at an administrator, candidate data comprising at least information pertaining to the candidate's professional abilities; receiving, at the administrator, employer data comprising at least information pertaining to the employer's employment needs; utilizing a processer, at the administrator, to compare the candidate data to the employer data based upon at least one predetermined criteria; and enabling a virtual audition between the candidate and the employer upon determination of a positive match between the candidate data and the employer data based upon the at least one predetermined criteria.

### CROSS-REFERENCE TO RELATED APPLICATIONS

This application claims priority to U.S. Provisional Patent Application Ser. No. 61/367,253, filed Jul. 23, 2010, entitled “Employment Matching System and Methods Thereof,” and to U.S. Provisional Patent Application Ser. No. 61/367,213, filed Jul. 23, 2010, entitled “Beauty-Industry Business Matching System And Methods Thereof,” the disclosures of which are incorporated by reference herein in their entireties.

### BACKGROUND OF THE INVENTION

1. Field of the Invention

Embodiments of the present invention are generally related to a business matching system and methods thereof for the creative arts industries. More specifically, embodiments of the present invention relate to a network-based system for matching a candidate with an open position of an employer within a predetermined creative arts industry and methods of utilizing and implementing the same.

2. Description of Related Art

In many industries, when an employer is looking to hire a new employee, review of a resume, writing sample, or other tangible form of quality assessment can be reviewed by the employer to determine if there is a good match. However, for industries involving creative arts, a writing sample will not provide an indication of the quality or skill set of an employment candidate.

The “beauty industry” is one of the most difficult to match employee/employer industries in the United States. As of 2010, there were 825,600 registered beauty industry businesses, including 340,600 spas, generating 37.5 billion dollars in sales (although other reports have these numbers as high as $81B, for the combined industries), annually. There needs to be noted that there is a chronic underestimation by the Bureau of Labor Statistics (BLS) of employment in the cosmetology industry. The BLS survey of establishments excludes proprietors, the unincorporated, and self-employed workers, which may account for the discrepancies between other surveys and the BLS data.

Of these businesses, the median breakdown in terms of reported positions, is as follows: 18 payroll employees, 10 work full-time (35 hours or more per week), while 8 employees work part-time (less than 35 hours a week). According to the Bureau of Labor Statistics, U.S. Census Bureau 2007 figures, there are currently more than 1.1 million professionals working in personal appearance occupations in the United States. It also reported that there is an anticipated growth in this industry of 14% by 2016, growing to 18.1% by 2018, which is faster than any other occupation.

Within that employment environment, there are additional staffing needs to employ 28% nail technicians, 13% shampoo assistants, 34% estheticians, and 40% makeup artists. This growth and employment projection does not include all the support staff that would be employed in medium to larger operations: general management, customer service staff, retail and marketing specialists.

These projections were based on 45% of the salons and spas positioned to add new services in 2006. Services that were expanded and contribute to the growth of this industry include hair extensions, eyelash extensions, facials, global massage and body treatments, as well as Botox.

The Salon Industry continues to be a diverse workforce with 85% of their employees being women (as opposed to Overall U.S. Workforce figure of 46%), 11% are African American, 14% Asian and 12% Hispanic.

The Salon/Spa Tracking Survey Report, published by PBA, at the third quarter 2009, cited labor indicators showed a net increase in staffing levels, with 26% of businesses surveyed adding employees between the third quarters of 2008 and 2009. Based on prior data from the US Labor Statistics and PBA, the industry doubled their employment between 2002 and 2009, from 535,297 to 1,100,000. This data combined further gives optimistic projections for new hires.

Forty-nine percent of salon/spa owners expect to have higher staffing levels in the next six months, while only two percent expect to employ fewer individuals in the next six months. Fifteen percent of the businesses surveyed have intentions to expand their operations to include another location or more. Specifically, 58% of the salon/spa owners in the $2 million of higher sales category, expect to add employees. This segment of the industry reports that 33% of these businesses intend to open at least one other establishment in the coming year. This represents approximately 100,000 new positions, conservatively.

In 2009, the Professional Beauty Association (PBA) and the International Spa Association (ISPA) reported a slow, but continued growth in the joint industry, of 2.8%. The Salon Industry, in particular, has been deemed the beneficiary of the ‘Lipstick Economy’, with its growth consistent through our national Recession ('08-'10). In fact, it is listed by American Observer, Sep. 23, 2008, as one of the Top 25 Recession Proof Industries.

One reason is the increased numbers of unemployed jobseekers, who must invest in their physical appearance in order to influence potential employers. There is also the growth primarily coming from an increasing population, which will lead to greater demand for basic hair services. Additionally, the demand for hair coloring and other advanced hair treatments has increased in recent years, particularly among baby boomers and young people. This trend is expected to continue, leading to a favorable outlook for hairdressers, hairstylists, and cosmetologists.

Additionally, fueled by continued improvements in service and retail sales along with higher customer traffic levels, the Professional Beauty Association's (PBA) Salon/Spa Performance Index (SSPI) hit a record high in the first quarter of 2010. The index, a quarterly composite index that tracks the health of, and outlook for, the U.S. salon/spa industry, stood at 103.1 in the first quarter, up 0.5% from its fourth quarter level.

The SSPI is based on the responses to PBA's Salon/Spa Industry Tracking Survey, which is fielded quarterly among 800 salon/spa owners nationwide on a variety of indicators. It is constructed so that the health of the salon/spa industry is measured in relation to a steady-state level of 100. Index values above 100 indicate that key industry indicators are in a period of expansion, while index values below 100 represent a period of contraction. The index consists of two components—the Current Situation Index and the Expectations Index.

The Current Situation Index, which measures current trends in five industry indicators (service sales, retail sales, customer traffic, employees/hours and capital expenditures), stood at 100.5 in the first quarter—up 0.6% from its fourth quarter level. In addition, the Current Situation Index rose above 100 for the first time in the five-quarter history of the SSPI, which represents expansion in the current situation indicators.

The Expectations Index, which measures salon/spa owners' six month outlook, considers the following five industry indicators: service sales, retail sales, employees and hours, capital expenditures and business conditions. Results of this index are encouraging and point toward broad-based industry growth. Four out of five salon/spa owners expect to have higher service sales and retail sales in the months ahead. Optimism in the direction of the overall economy has prompted owners' plans to raise their number of staff and increase capital expenditures invested in either expansion or remodeling in the next six months. In addition, the long-term outlook for job prospects in the spa industry is very positive, according to newly released projections (December 2009) by the U.S. Bureau of Labor Statistics (BLS).

According to BLS projections, the number of personal appearance jobs at employment-based establishments will jump 31% between 2008 and 2018. Among personal appearance occupations, BLS expects the number of skin care specialists to grow by more than 50% between 2008 and 2018, while the number of hairdresser, hairstylist and cosmetologist positions at employment-based establishments is expected to grow by 31%. The full SSPI report and the Salon/Spa Tracking Survey can be found at www.probeauty.org/businesstools/research.

Continued growth in the number full-service spas and nail salons will also generate numerous job openings for manicurists and pedicurists, whose forecasted growth will be by 19 percent, faster than average.

These additional employment opportunities were responsible for the sales growth in the Salon and Spa segment between 1997 and 2006, of a 64% gain.

Job opportunities generally should be good, particularly for licensed personal appearance workers seeking entry-level positions. A large number of job openings will come about from the need to replace workers who transfer to other occupations, retire, or leave the labor force for other reasons.

However, workers can expect keen competition for jobs and clients at higher paying salons, as these positions are relatively few and require applicants to compete with a large pool of licensed and experienced cosmetologists. Opportunities will generally be best for those with previous experience and for those licensed to provide a broad range of services.

The PBA and ISPA Report 2009, show that one of the (continuous) Top Three Challenges for all salon and spa owners is recruiting and retaining employees. Furthermore, with expansion on the horizon for the portion of the industry that is doing the highest volume, there is a shortage of a superior labor pool, which makes recruitment harder, more expensive and more time consuming.

The NAACAS 2007 Report, previously introduced, stated that in 2007, 54% of ALL registered businesses posted job listings (446,040), with 39% not able to fill the (172,955) positions because they “could not find properly trained people.” Thus, the single, most unreported expense in the Salon and Spa Industry is the Cost of Employee Turnover. Turnover is defined by a loss of an employee, voluntarily or otherwise.

There are various opinions and formulae for calculating this most highly under reported cost, that of employee turnover. For instance, according to Harvard Business Review (HBR) report, Jan. 29, 2009, by Linda Gabcock and Sara Laschew, the cost of employee turnover is approximately half of an hourly wage earners annual salary. Based on their calculation, they feel a mid-size company can lose up to 3.4% in gross revenues, as a result of the turnover costs. According to Hoovers, 2010, the average revenue earned, on average, by a salon or spa employee is just under $45,000. Using the HBR formula, the employee turnover cost for salons and spas, on average is $22,500. In an independent study by Hewitt Associates, estimates of the total cost of losing a single position to turnover range from 30 percent of the yearly salary for hourly employees, to 150 percent. SHRM, the Society for Human Resource Management, has estimated that it costs $3,500.00 to replace one $8.00 per hour employee. SHRM's estimate was the lowest of 17 nationally respected companies who calculate this cost. Since the average salon and spa employee is earning approximately $21.50 hourly, based on this formula, it would cost $9,406.00 to replace that individual.

In a 2009 Professional Beauty Association (PBA) Financial Study, in conjunction with ISPA (International Spa Association), the industries turnover rate is double that of national averages in other industries, with full time employees at 26% and part time at 36%. It is safe to assume, therefore, that the ‘average’ business is losing $9,406.00 for each staff member exiting, who based on this industry report are approximately one in three employees.

The impact of employee turnover is significant, and can be captured by each individual business by calculating the costs associated in these processes: Recruiting new talent of equal caliber, Interviewing, Hiring, Orientation, Training, Compensation & Benefits while training, Lost productivity, Customer dissatisfaction, Reduced or lost business, Administration, Lost expertise, Loss of company confidential data/trade secrets, and Temporary workers.

While calculating the actual cost of employee turnover is not a norm, even among very large businesses, they instinctively know something is wrong. The revenue numbers slip, clientele drops off, a competitor launches a copycat marketing strategy, and the remaining staff seems disengaged and de-motivated.

In a recent survey, 66-75% of all employees are dissatisfied in their current job. Dissatisfied employees are less productive and have a negative effect on existing staff.

For the disenfranchised technician, there are as many disruptive challenges in their lives: loss of cash flow, loss of client contact and records, job seeking, interviewing and auditioning appointments, assimilation to new surroundings, policies and peers. Numbers of estimated interviews before landing a good position run from 10 to 40.

Thus, there is a need for an employment matching system and methods thereof to enable candidates in a creative arts industry to be matched to an open employment position with an employer, yielding improved results in the job placement and turnover rate.

### SUMMARY

Embodiments of the present invention are generally related to a business matching system and methods thereof for the creative arts industries. More specifically, embodiments of the present invention relate to a network-based system for matching a candidate with an open position of an employer within a predetermined creative arts industry and methods of utilizing and implementing the same.

In one embodiment of the present invention, a method of matching business personnel in the creative arts industries comprises: receiving, at an administrator, candidate data comprising at least information pertaining to the candidate's professional abilities; receiving, at the administrator, employer data comprising at least information pertaining to the employer's employment needs; utilizing a processer, at the administrator, to compare the candidate data to the employer data based upon at least one predetermined criteria; and enabling a virtual audition between the candidate and the employer upon determination of a positive match between the candidate data and the employer data based upon the at least one predetermined criteria.

In another embodiment of the present invention, a method of matching business personnel in the creative arts industries comprises: receiving, at an administrator, multimedia data pertaining to a candidate's skill set relative to an employer's employment needs; receiving, at the administrator, employer data comprising a prioritized set of criteria for an open position that meets the employer's employment needs; utilizing a processer, at the administrator, to compare the candidate data to the employer data based upon at least one predetermined criteria; and enabling a virtual audition between the candidate and the employer upon determination of a positive match between the candidate data and the employer data based upon the at least one predetermined criteria, the virtual audition comprising comprises a transmission of data regarding a real-world scenario involving a candidate's skill set with regards to employer's employment needs; wherein the creative arts industries comprise at least the beauty industry, culinary industry, visual art industry, graphic arts industry, music industry, floral industry, entertainment industry, fashion industry, professional industry, or combinations thereof.

In yet another embodiment of the present invention, a system for matching business personnel in the creative arts industries comprises: a candidate comprising a network-accessible communication device; an employer comprising a network-accessible communication device; and an administrator hosting a computer device on a network, the computer device in communication with the candidate and the employer through the network, and the computer device comprising a memory for storing instructions and a processor for executing the instructions; wherein the instructions comprise executable steps for enacting a method, the method comprising: receiving, at the administrator, candidate data comprising at least information pertaining to the candidate's professional abilities; receiving, at the administrator, employer data comprising at least information pertaining to the employer's employment needs; utilizing the processer to compare the candidate data to the employer data based upon at least one predetermined criteria; and enabling a virtual audition between the candidate and the employer upon determination of a positive match between the candidate data and the employer data based upon the at least one predetermined criteria.

### BRIEF DESCRIPTION OF THE DRAWINGS

So the manner in which the above recited features of the present invention can be understood in detail, a more particular description of embodiments of the present invention, briefly summarized above, may be had by reference to embodiments, one of which is illustrated in the appended drawings. It is to be noted, however, the appended drawings illustrate only typical embodiments of embodiments encompassed within the scope of the present invention, and, therefore, is not to be considered limiting, for the present invention may admit to other equally effective embodiments.

FIG. 1 depicts a network-based system in accordance with one exemplary embodiment of the present invention;

FIG. 2 depicts a general purpose computer system in accordance with one embodiment of the present invention;

FIG. 3 depicts an exemplary data structure in accordance with one exemplary embodiment of the present invention;

FIG. 4 depicts a flow chart of a method for obtaining candidate data in accordance with one embodiment of the present invention;

FIG. 5 depicts a flow chart of a method for obtaining employer data in accordance with one embodiment of the present invention; and

FIG. 6 depicts a flow chart of a method for matching a candidate with an open position of an employer in accordance with one exemplary embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to a business matching system and methods thereof for the creative arts industries. More specifically, embodiments of the present invention relate to a network-based system for matching a candidate with an open position of an employer within a predetermined creative arts industry and methods of utilizing and implementing the same.

As used herein, “creative arts industry,” or derivatives thereof, is intended to be inclusive of all industries having personnel and/or individuals utilizing particular skill sets, where the entire scope of such skill sets cannot be ascertained by a prospective employer, client, etc., without an interactive encounter with such personnel and/or individuals. For example, the creative arts industry includes the beauty industry (i.e., inclusive of hair, skin, makeup, etc.), culinary industry (e.g., cook, baker, etc.), visual art industry (e.g., sculptor, painter, draftsman, filmographer, photographer, etc.), graphic arts industry (e.g., graphic designer, website designer, etc.), music industry (e.g., musician, singer, producer, etc.), floral industry (e.g., florist, farmer/horticulturalist, etc.), entertainment industry (e.g., comedian, actor/actress, etc.), fashion industry (e.g., clothing designer, model, etc.), professional industry (e.g., attorney, medical professional, accountant), or the like.

As used herein, “employment matching” is understood to not be limited to employer and employee relationships, and rather includes all forms of such relationships. Thus, the parties in the disclosed “employment matching” systems and methods may include: employers, employees, independent contractors, suppliers, vendors, customers, clients, agents, interns, volunteers, or the like. Accordingly, as understood by those of ordinary skill in the art, embodiments of the present invention are not limited to or by the type of relationship created between any two parties herein, and should be inclusive of any type of arrangement between two or more people that ordinarily exists in the creative arts industries.

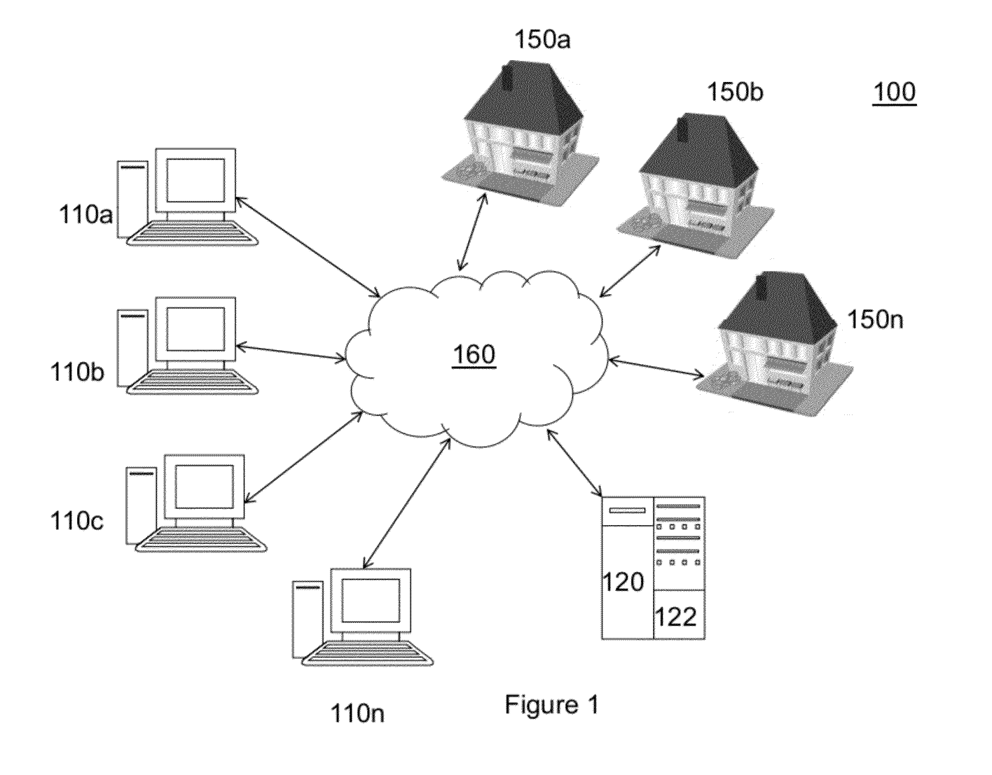

FIG. 1 depicts a network-based system in accordance with one exemplary embodiment of the present invention. The system 100 generally includes at least a first candidate 110a, also referred to herein as an end user or a user. The system 100 may additionally include at least a second candidate 110b, and additional candidates, up to candidate 110n, where n represents any number of candidates practical for operation of embodiments of the present invention. The system 100 further includes at least a first employer 150a. The system 100 may additionally include at least a second employer 150b, and additional employers, up to employer 150n, where n represents any number of employers practical for operation of embodiments of the present invention.

While embodiments of the present invention may relate to a plurality of candidates or employers, it is noteworthy that employers and candidates in any given embodiment of the present invention relate to a single and specific industry for employment opportunities. In accordance with embodiments of the present invention, exemplary industry-specific professionals may comprise graphic designers, culinary specialists, musicians, or any other professional whose career stems from the ability to create an artistic expression of some form, whether audible, visual, edible, tangible or the like. In the beauty industry, exemplary professionals may comprise technicians, for example, hairdressers, hair colorists, hair designers, hair cutters, barbers, shampoo assistants, nail technicians, pedicurists, facialists, estheticians, massage therapists, aromatherapists, reflexologists, spa attendants, make-up artists, waxing specialists, threaders or the like. In other embodiments, the exemplary professionals may comprise business managers, customer service representatives, administrative representatives, business directors, call center representatives, retail managers, public relations/event directors, hospitality leads, marketing managers, global managers, buyers, accounts payable/receivable representatives, bookkeepers, maintenance crews, launderers, and retail specialists.

The system 100 further comprises an administrator or host 120, i.e., an organization, company or individual who controls, designs and is generally responsible for implementing and/or facilitating each of the methods disclosed herein. As is common in network-based business models, the administrator 120 may also comprise a web administrator, responsible for providing and maintaining a website or interactive portal through which all of the candidates 110 or users of the system 100 may interact and execute the methodology and functionality disclosed in the embodiments disclosed herein.

In one embodiment, the administrator 120 is an entity hosting an accessible server and a database 122. The server may comprise any type of computing device suitable for embodiments of the present invention. The server may be located at the administrator 120 physical site or at a remote location accessible via the network 160.

The database 122 may include a number of records in accordance with embodiments of the present invention, including data and/or other information, which may be parsed and stored. The database 122 may further comprise software, which may include and/or employ one or more database management systems (“DBMS”), such as any one of an Oracle, DB2, Microsoft Access, Microsoft SQL Server, Postgres, MySQL, 4th Dimension, FileMaker and Alpha Five DBMS, and the like. The DBMS may be operable to query the database 122, parse the information into the records, execute rules for sorting the information parsed into the records, execute rules for performing operations (e.g., mathematical, statistical, logical, etc., operations) on the information parsed into the records, and the like.

In many embodiments, the database software may be operable to apply the data from records into one or more models to form one or more output records. These output records include information that may be used to facilitate the employment matching methods as disclosed herein. In addition, the database software may be operable to interface with web-server software, to allow manipulation of the database 122 via one or more web pages available to the administrator 120 via the network 160.

The network 160 may comprise any network suitable for embodiments of the present invention. For example, the network 160 may be a partial or full deployment of most any communication/computer network or link, including any of, any multiple of, any combination of or any combination of multiples of a public or private, terrestrial wireless or satellite, and wireline networks or links. The network 160 may include, for example, network elements from a Public Switch Telephone Network (PSTN), the Internet, core and proprietary public networks, wireless voice and packet-data networks, such as 1G, 2G, 2.5G, 3G and 4G telecommunication networks, wireless office telephone systems (WOTS) and/or wireless local area networks (WLANs), including, Bluetooth and/or IEEE 802.11 WLANs, wireless personal area networks (WPANs), wireless metropolitan area networks (WMANs) and the like; virtual local area networks (VLANs) and/or communication links, such as Universal Serial Bus (USB) links; parallel port links, Firewire links, RS-232 links, RS-485 links, Controller-Area Network (CAN) links, and the like.

In accordance with many embodiments of the present invention, each of the parties associated with the system 100 comprise the necessary electronic devices, having platforms and databases where applicable, to execute the methods as set forth by embodiments of the present invention. Alternative system architectures are contemplated by embodiments of the present invention provided such alternative architectures are capable of executing the various methods disclosed herein.

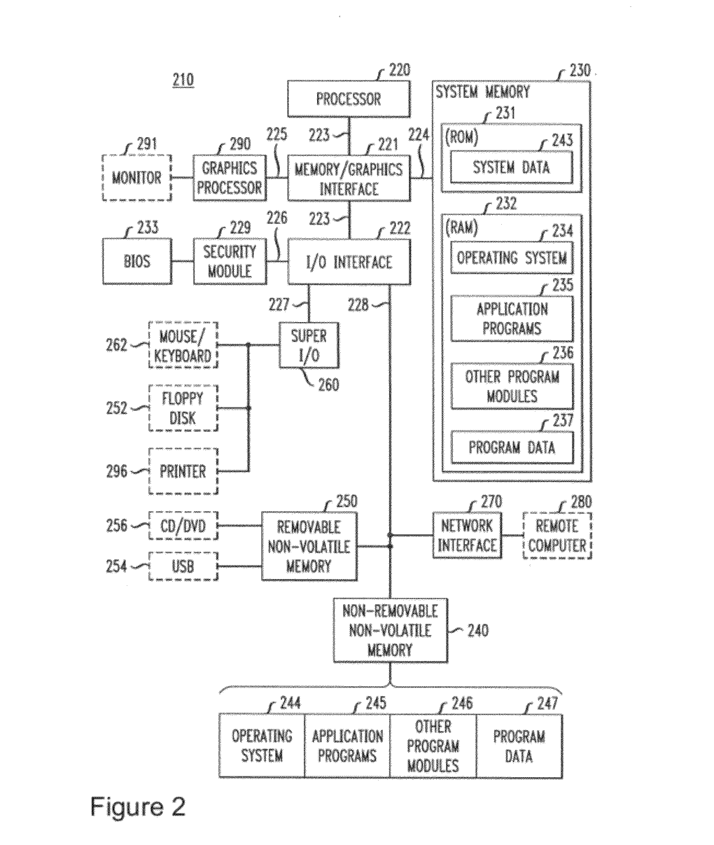

In several embodiments, the electronic device associated with each of the parties within the system comprises a general purpose computer system, for example, the general purpose computer system of FIG. 2. It should be appreciated, however, the general purpose computing system of FIG. 2 is merely an exemplary embodiment of an electronic device, and actual electronic devices may comprise any one or more components shown in FIG. 2, suitable for embodiments of the present invention.

With reference to FIG. 2, a general purpose computer system in the form of a computer 210 is shown. As understood by embodiments of the present invention, components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and can accessed by the computer 210.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other buses 226, 227 and 228 that couple a variety of internal and external devices to the computer 210. A serial peripheral interface (SPI) bus 226 may connect to a BIOS memory 233 containing the basic routines that help to transfer information between elements within computer 210, such as during start-up.

In some embodiments, a security module 229 may be incorporated to manage metering, billing, and enforcement of policies.

A super input/output chip 260 may be used to connect to a number of ‘legacy’ peripherals, such as floppy disk 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 252 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media, discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different elements within the computer 210. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), an Ethernet-based network, a wide area network (WAN), or both, but may also include other networks. Such networking environments are commonplace in offices, enterprise-wide computer networks, intranets, and the Internet.

It should be appreciated by embodiments of the present invention, execution of the methods and functions described herein with respect to the network may be executed by not only a physical computing device, for example, as shown in FIG. 2, but also on a virtual machine. Accordingly, although many physical elements are disclosed herein, the virtual equivalent of such elements may be implemented on a virtual platform without any deviation from the methods and functions disclosed herein.

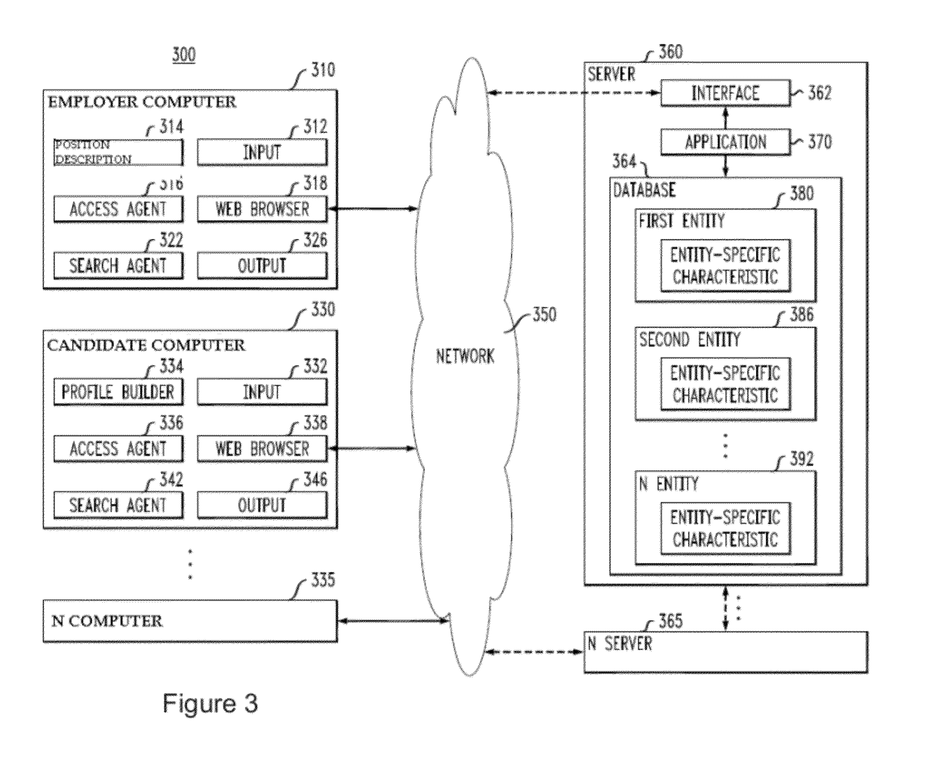

FIG. 3 depicts an exemplary data structure within a system in accordance with one exemplary embodiment of the present invention. The system 300 generally comprises an employer computer 310, a candidate computer 330, a network 350, and a server 360. Optionally, a plurality of additional employer and/or candidate computers 335 (hereinafter “N Computer”) and/or servers 365 (hereinafter “N Server”) may be provided, wherein N represents any number of employer and/or candidate computers and servers practical for operation of embodiments of the present invention. The N computers 335 and/or N Servers 365 may be utilized without deviating from the scope of embodiments of the present invention.

In one embodiment, the employer computer 310 comprises an input device 312, an output device 326, and a web browser 318 for connecting to the server 360 through the network 350. The employer computer 310 may optionally comprise any number of application tools, e.g., a position description builder 314, access agent 316, and search agent 322, which may assist with using and navigating the system 300 from the first client computer 310. Each of the position description builder 314, access agent 316 and search agent 322 may comprise software or other computer readable medium having instructions to execute a plurality of steps in accordance with embodiments of the present invention.

The input device 312 comprises at least one input device, including but not limited to a mouse, a keyboard, a touch screen, a microphone, and a data input drive, and the like. The output device 326 comprises at least one output device, including but not limited to headphones, speaker(s), a video monitor, a computer monitor, a printer, an electronic output, and the like.

The candidate computer 330 similarly comprises an input device 332, an output device 346, an interface 338 for communicating with the server 360 through the network 350, a profile builder 334, access agent 336, and search agent 342, which may assist with using and navigating the system 300 from the candidate computer 330. The input device 332 and output device 346 may be substantially similar to the input device 312 and output device 326 of the first client computer 310, respectively.

Generally, the network 350 may comprise any network suitable for embodiments of the present invention, including, for example, a global computer network, an internal network, local-area networks, wireless networks, and the like. Any of the networks described above with respect to FIG. 1 may be utilized herein.

The server 360 generally comprises an interface 362, a database 364, and application 370 for facilitating and/or executing many of the operations described herein within the server 360. The interface 362 is configured to communicate with the employer computer 310 and the candidate computer 330 through the network 350. The database 364 may be any data storage database suitable for embodiments of the present invention. For example, the database 364 comprises at least one or more database management systems, such as any of an Oracle, DB2, Microsoft Access, Microsoft SQL Server, Postgres, MySQL, 4th Dimension, FileMaker, Alpha Five Database Management System, or those described above with respect to FIG. 1.

Contained within the database 364 is a plurality of data sets, each comprising specific data. A first data set 380 may correlate to a first entity, whereby an entity is an individual, organization, group, business, or other defined body (i.e., either an employer or a candidate). Within the first data set 380, a plurality of entity-specific data is provided. A second data set 386 may correlate to a second entity, and within the second data set 386, a plurality of entity-specific data may be provided. The database 364 may also include any number of subsequent data sets 392 representing N entities (hereinafter “N entity”), wherein N represents any number of entities practical for operation of embodiments of the present invention.

The entity-specific characteristics may include any characteristic, quality, need or desire of an entity regarding an employment position, or the like. In accordance with an exemplary embodiment of the present invention, the entity-specific characteristic is a candidates desire to seek employment. In yet another embodiment of the present invention, the entity-specific characteristic is the entity's desire to gain information. Other similar types of characteristics may also be included in the respective data sets within the database 364. As understood by those of ordinary skill in the art, any type of data suitable for embodiments of the present invention may be stored as an entity-specific characteristic for the respective entity.

The application 370 comprises any number of software or instruction-based packages for facilitating user interaction with the database. In one embodiment, the application 370 comprises a data portal, accessible through a web page, for allowing the user to access, update or modify information stored on the database 364. In another embodiment, the application 370 comprises software for enabling query searching within the database 370. Such query searching is generally integral with many commercially available database programs, and thus, is understood by those of ordinary skill in the art.

The application 370 may additionally facilitate interaction between the server 360 and a secondary server (e.g., a social networking server (not shown)), which is provided to host ordinary components of a social network, e.g., profile information, chat capabilities, multimedia storage and the like. In such an embodiment, the application 370 may directly communicate with the social networking server for allowing a user to access information, utilities and other applications contained thereon, while still allowing the user to access information stored within the database 364 on server 360. In some alternative embodiments, a user may directly connect with such a secondary server, which in turn is in communication with the server 360 to provide access to information stored within the database 364.

A memory (not shown) may also be provided within the server 360, outside of the database 364. In such an embodiment, the memory may be utilized to store information and executable instructions associated with the system 300, as described above. For example, in accordance with one embodiment of the present invention, the memory may store an entity profile for each user associated with the system 300. The entity profile may contain information relating to an entity-specific characteristic of a corresponding entity or user.

In one embodiment, an employer may be able to create at least a portion of an entity profile associated with that entity through use of a position description builder 314 located on the employer computer 310. Likewise, a candidate may be able to create at least a portion of an entity profile associated with the candidate through use of a profile builder 334 located on the candidate computer 330. Whereas the basic concepts of these network architectures are generally known, no further description is provided.

In another embodiment of the present invention, a verification device (not shown) may be included in the system 300. The verification device may be adapted to verify the legitimacy of information or data contained in an entity profile. Such verification device may comprise applications for generating verifiable emails (i.e., emails sent to a user requiring additional steps before an account is activated), phone verifications (i.e., phone call placed to a user to verify account information), or the like.

In another embodiment of the present invention, the system 300 may include a revenue generating system (not shown). The revenue-generating system may comprise additional application(s) or executable instructions for monitoring activity within the system and allocating a fee associated with such activity. For example, in one embodiment, the revenue generating system may monitor an interaction between a first entity 380, a second entity 386, or an N entity 392, during a use of the system of employment matching 300, e.g., emails, attempted solicitations/contacts, etc. In another example, an access fee may be charged to at least one of the first entity 380, the second entity 386, and an N entity 392 for using the system 300. In yet another example, the revenue generating system may include a commercial advertisement banner, pop-up, or the like. In such an example, the administrator of the system 300 may charge third parties to advertise products, businesses, or the like on the system, and charge a fixed, flexible, temporal or adjustable rate for such advertisement. This type of advertising is well known in web based systems, and as such, no further description will be provided.

In some embodiments of the present invention, a value calculator (not shown) may be included in the system 300. In this accord, the value calculator may be adapted to calculate a weighted value based on the veracity, scope of information, number of views/hits, etc., of an entity's profile or entity-specific characteristic. The value calculator may utilize any variation of algorithm suitable for embodiments of the present invention. By utilizing a value calculator, individual entity-specific characteristics may be valued, such that when the database 364 is queried for matching entity-specific characteristics, the database may provide better results based on a high value received from the value calculator.

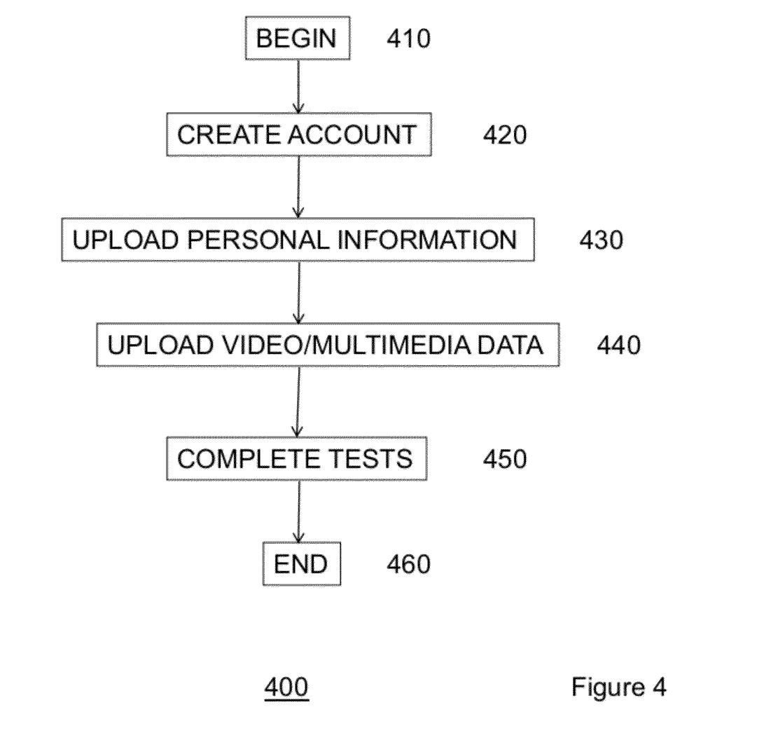

FIG. 4 depicts a flow chart of a method for obtaining candidate data in accordance with one embodiment of the present invention. FIG. 4 may be described generally in relation to the systems depicted in FIGS. 1 and 3. The method 400 starts at step 410 where a system, such as the system 100 of FIG. 1 is provided. At step 420, a candidate creates an account on system 100. It is understood that a candidate may create account by using any of the known methods in the art including, but not limited to, standard username and password login procedures. In an alternative embodiment of the invention, the candidate may have to pay a fee in order to gain access to system 100 and create an account.

At step 430, the candidate may upload personal information into the system. The candidate may upload personal information into the system using any known input devices known in the art including, but not limited to, keyboard, microphone, etc. Personal information may include, but is not limited to, a resume, the type of employment position sought, past employment history, desired compensation, relocation possibility, licensing information and start date availability.

At step 440, the candidate may upload multimedia data related to the industry-specific field. Multimedia data may include, but is not limited to, video, audio, and textual documents in any format known to those skilled in the art. In one embodiment of the present invention, the candidate may upload an introduction video, which gives the employer an idea of the candidate's communication skills, passion for work in the related field, overall image of the candidate, etc. In certain embodiments, the candidate may upload still shots or video of his/her work, e.g., styling an individual's hair or nails, baked products for a chef, exemplary web pages for a graphic artist, or the like.

At step 450, the candidate may be required to complete one or more tests. These tests may be of varying formats specific to job functions as posted by employers. In several embodiments of the present invention, these tests will help identify the work style, personality, intellectual and/or emotional quotient of each individual. For example, these tests may include, but are not limited to, personality tests, cognitive aptitude tests, and the Myers-Briggs test. Other suitable tests may include pre-employment tests, for example, those commercially available from Criteria Corp., sold under the HireSelect® brand. At step 460, the method ends.

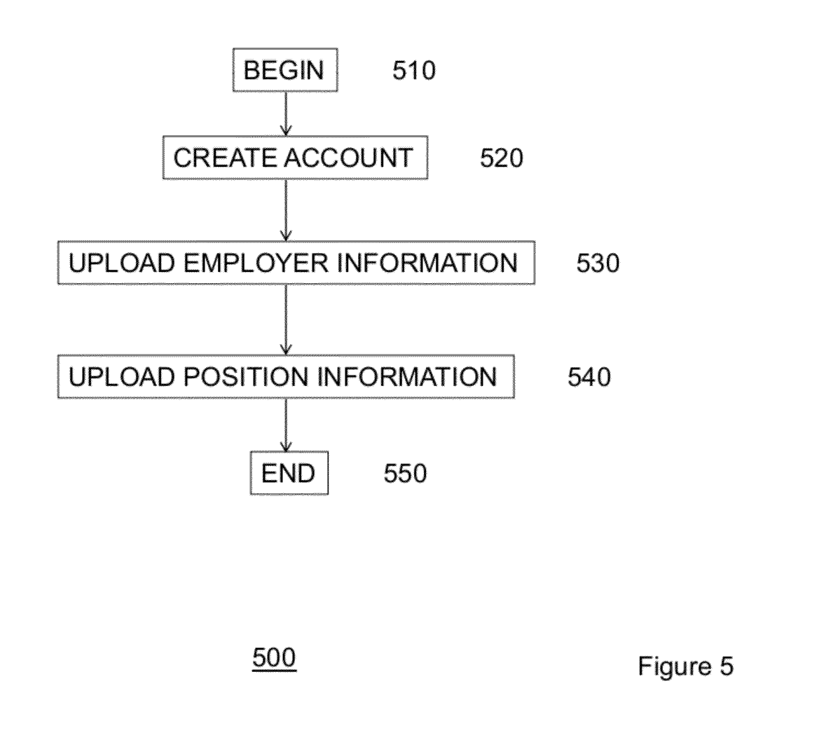

FIG. 5 depicts a flow chart of a method for obtaining employer data in accordance with one embodiment of the present invention. The method 500 starts at step 510 where a system, such as the system 100 of FIG. 1 is provided. At step 520, an employer creates an account on system 100. It is understood that an employer may create an account by using any of the known methods in the art including, but not limited to, standard username and password login procedures. In an alternative embodiment of the invention, the employer may have to pay a fee in order to gain access to system 100 and create an account.

At step 530, the employer uploads employer information. Employer information may include, but is not limited to, contact information, location information, mission statements, company history, employee listings or the like.

At step 540, the employer uploads position information. Position information may include, but is not limited to, any available positions for hire, duties of the position, hours worked required by each position, and wage information.

In addition to providing basic information regarding the position, the employer may also be asked to provide a priority list of criteria for the open position. For example, in one embodiment, the employer may be presented with a pre-set list of possible characteristics an ideal employee should possess. In such an embodiment, the employer may be asked to rank such characteristics in a priority order. In another embodiment, the employer may be asked to pick a sub-set of the total number of possible characteristics and provide more detailed information regarding such desired characteristics of the candidate. In accordance with embodiments of the present invention, by providing such desired characteristics, the system will be able to process and locate matches with candidates having a higher likelihood of suitability for the employer's position.

In one exemplary embodiment, an employer may be able to select from at least twenty-eight characteristics. In such an exemplary commercial embodiment, the employer may be able to choose up to a set number (e.g., five) of the characteristics which the employer considers most critical to a potential candidate.

At step 550, the method ends.

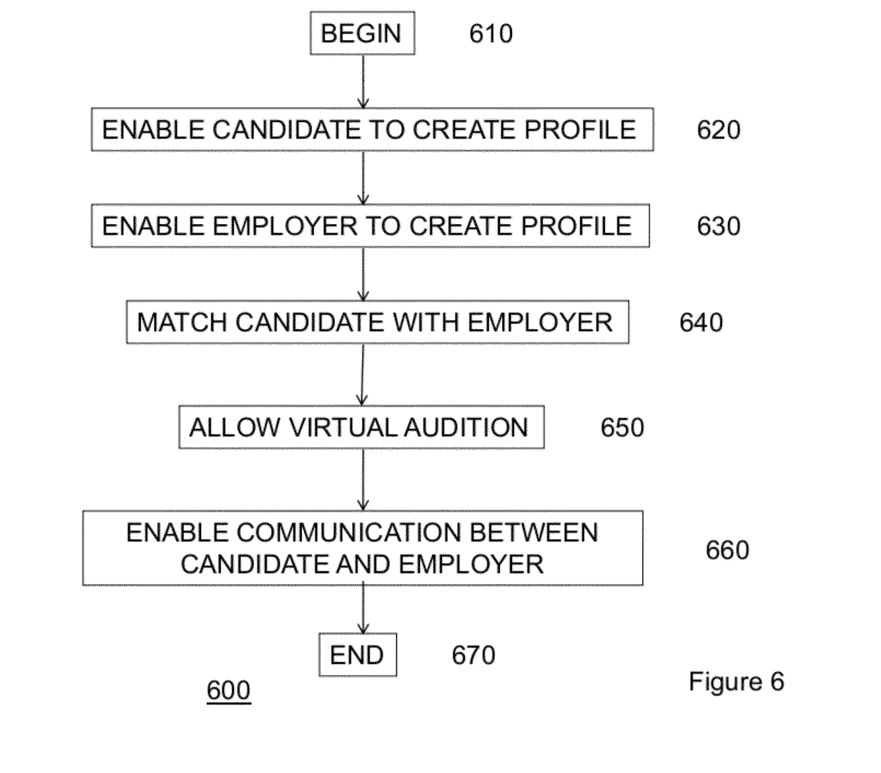

FIG. 6 depicts a global flow chart of a method for matching a candidate with an open position of an employer in accordance with one exemplary embodiment of the present invention. The method 600 starts at step 610.

At step 620, the candidate creates a profile. In many embodiments, the candidate may create a profile utilizing the method disclosed supra with respect to FIG. 4. However, any suitable means for creating a profile may be utilized in accordance with embodiments of the present invention.

At step 630, the employer creates a profile. In many embodiments, the employer may create a profile utilizing the method disclosed supra with respect to FIG. 5. However, any suitable means for creating a profile may be utilized in accordance with embodiments of the present invention.

At step 640, a candidate is matched with an employer. Generally, in view of the uploaded information from both the candidate and the employer regarding the open position, a match can be made. Utilizing proprietary algorithms in view of the features and elements described herein, the match may be based on any number of desired characteristics by the employer and attributes of the candidate. Once a match occurs, the employer may be notified by any virtual means (e.g., email, telephone, instant message, etc.) of the match, at which time the employer will be able to review the candidates information and determine if the candidate should continue in the interview/matching process.

Optionally, once a match is made, or at any other time during the methods disclosed herein, a background security check may be conducted on the candidate. Such background security checks may include a review of any criminal history, credit checks, employment references, educational references, or the like. In certain embodiments, the optional background security check may be contracted out to a third party for completion.

At step 650, a virtual audition is enabled. In accordance with one embodiment of the present invention, an employer may request a virtual audition of a desired candidate with whom the employer has been matched. Generally, a “virtual audition” comprises any transmission of data regarding a real-world scenario involving the candidate's skill set with regards to the open employment position by the employer. In one embodiment, the virtual audition comprises a recordation of the candidate engaging in a predetermined activity, selected by the employer, that the candidate would be expected to know how to complete if hired by the employer. For example, in an embodiment where the open position is for a hair stylist, the employer may request the candidate provide multimedia data regarding styling an individual's hair in a particular style of fashion. Similarly, in an exemplary embodiment where the open position is for a chef, the employer may request the candidate provide multimedia data regarding the preparation and presentation of a particular culinary dish. In alternative embodiments, the predetermined activity could include, for example, designing a web page, creating a painting, forming a sculpture, drawing a picture, assembling a floral arrangement, acting out a skit, designing a dress, conducting a medical procedure, or the like. The candidate would then be required, within a predetermined timeline, to conduct such activity, create a multimedia recording thereof, and upload the same to the system for the employer's review.

In accordance with embodiments of the present invention, the candidate may utilize any form of multimedia data to conduct the virtual audition. In one embodiment, the virtual audition is conducted via a video recording using any type of video recording device available to the individual. Generally, videos created with cell phones, smart phones, video cameras, webcams or the like, are all deemed acceptable forms of multimedia data. In alternative embodiments, for example, in the music industry, audio data may be acceptable, or similarly, in the graphic arts industry, still images may be acceptable.

At step 660, if the employer is satisfied with the candidate's qualifications and virtual audition, the employer may contact the candidate directly through any known means of communication. This communication may include, but is not limited to, real-time chat, real-time video chat, phone interview, and personal interview. During this step, the employer may also reach out the candidate to extend a job offer, discuss specific employment terms, or the like. At step 670, the method ends.

While the foregoing is directed to embodiments of the present invention, other and further embodiments of the invention may be devised without departing from the basic scope thereof. Specifically, embodiments of the present invention are further scalable to allow for additional clients and servers, as particular applications may require.

What is claimed is:

1. A method of matching business personnel in the creative arts industries comprising:
receiving, at an administrator, candidate data comprising at least information pertaining to the candidate's professional abilities;
receiving, at the administrator, employer data comprising at least information pertaining to the employer's employment needs;
utilizing a processer, at the administrator, to compare the candidate data to the employer data based upon at least one predetermined criteria; and
enabling a virtual audition between the candidate and the employer upon determination of a positive match between the candidate data and the employer data based upon the at least one predetermined criteria.

2. The method of claim 1, wherein the creative arts industries comprise at least the beauty industry, culinary industry, visual art industry, graphic arts industry, music industry, floral industry, entertainment industry, fashion industry, professional industry, or combinations thereof.

3. The method of claim 1, wherein the candidate data comprises multimedia data pertaining to the candidate's skill set relative to the employer's employment needs.

4. The method of claim 1, wherein the candidate data comprises a set of responses to questions on a standardized test, the standardized test for providing an indication of the candidate's work style, personality, intellectual quotient, emotional quotient, or combinations thereof.

5. The method of claim 1, wherein the employer data comprises a prioritized set of criteria for an open position that meets the employer's employment needs.

6. The method of claim 5, wherein the prioritized set of criteria is selected from twenty-eight possible criterion.

7. The method of claim 5, wherein the at least one predetermined criteria utilized to compare the candidate data to the employer data comprises at least one of the prioritized set of criteria.

8. The method of claim 1, wherein enabling a virtual audition comprises a transmission of data regarding a real-world scenario involving a candidate's skill set with regards to employer's employment needs.

9. The method of claim 8, wherein the data regarding a real-world scenario comprises a recordation of the candidate engaging in a predetermined activity, selected by the employer, that the candidate would be expected to know how to complete if hired by the employer.

10. The method of claim 9, wherein the predetermined activity comprises one of styling an individual's hair in a particular style of fashion, preparation and presentation of a particular culinary dish, designing a web page, creating a painting, forming a sculpture, drawing a picture, assembling a floral arrangement, acting out a skit, designing a dress, conducting a medical procedure.

11. A method of matching business personnel in the creative arts industries comprising:
receiving, at an administrator, multimedia data pertaining to a candidate's skill set relative to an employer's employment needs;
receiving, at the administrator, employer data comprising a prioritized set of criteria for an open position that meets the employer's employment needs;
utilizing a processer, at the administrator, to compare the candidate data to the employer data based upon at least one predetermined criteria; and
enabling a virtual audition between the candidate and the employer upon determination of a positive match between the candidate data and the employer data based upon the at least one predetermined criteria, the virtual audition comprising comprises a transmission of data regarding a real-world scenario involving a candidate's skill set with regards to employer's employment needs;
wherein the creative arts industries comprise at least the beauty industry, culinary industry, visual art industry, graphic arts industry, music industry, floral industry, entertainment industry, fashion industry, professional industry, or combinations thereof.

12. The method of claim 11, further comprising:
receiving, at an administrator, a set of candidate responses to questions on a standardized test, the standardized test for providing an indication of the candidate's work style, personality, intellectual quotient, emotional quotient, or combinations thereof.

13. The method of claim 11, wherein the prioritized set of criteria is selected from twenty-eight possible criterion.

14. The method of claim 11, wherein the at least one predetermined criteria utilized to compare the candidate data to the employer data comprises at least one of the prioritized set of criteria.

15. The method of claim 11, wherein the data regarding a real-world scenario comprises a recordation of the candidate engaging in a predetermined activity, selected by the employer, that the candidate would be expected to know how to complete if hired by the employer.

16. The method of claim 15, wherein the predetermined activity comprises one of styling an individual's hair in a particular style of fashion, preparation and presentation of a particular culinary dish, designing a web page, creating a painting, forming a sculpture, drawing a picture, assembling a floral arrangement, acting out a skit, designing a dress, conducting a medical procedure.

17. A system for matching business personnel in the creative arts industries comprising:
a candidate comprising a network-accessible communication device;
an employer comprising a network-accessible communication device; and
an administrator hosting a computer device on a network, the computer device in communication with the candidate and the employer through the network, and the computer device comprising a memory for storing instructions and a processor for executing the instructions;
wherein the instructions comprise executable steps for enacting a method, the method comprising:
receiving, at the administrator, candidate data comprising at least information pertaining to the candidate's professional abilities;
receiving, at the administrator, employer data comprising at least information pertaining to the employer's employment needs;
utilizing the processer to compare the candidate data to the employer data based upon at least one predetermined criteria; and
enabling a virtual audition between the candidate and the employer upon determination of a positive match between the candidate data and the employer data based upon the at least one predetermined criteria.

18. The system of claim 17, wherein the creative arts industries comprise at least the beauty industry, culinary industry, visual art industry, graphic arts industry, music industry, floral industry, entertainment industry, fashion industry, medical industry or combinations thereof.

19. The system of claim 17, wherein enabling a virtual audition comprises a transmission of data regarding a real-world scenario involving a candidate's skill set with regards to employer's employment needs, the real world scenario comprising a recordation of the candidate engaging in a predetermined activity, selected by the employer, that the candidate would be expected to know how to complete if hired by the employer.

20. The system of claim 19, wherein the predetermined activity comprises one of styling an individual's hair in a particular style of fashion, preparation and presentation of a particular culinary dish, designing a web page, creating a painting, forming a sculpture, drawing a picture, assembling a floral arrangement, acting out a skit, designing a dress, conducting a medical procedure.
